(19) United States
(12) Patent Application Publication
(10) Pub. No.: US 2026/0247518 A1
(43) Pub. Date: Aug. 20, 2026

(54) PLASMA TORCH HEAD FOR INTERIOR COATINGS AND METHOD OF MANUFACTURING THE TORCH HEAD

(71) Applicants: OERLIKON METCO AG, WOHLEN, Wohlen (CH); OERLIKON METCO (US) INC., Westbury, NY (US)

(72) Inventors: Ricardo CRUZ, Villmergen (CH); Marco PAOLOZZI, Bremgarten (CH); Michel MESSINA, Hunzenschwil (CH); Alexander MICHLA, Bad Säckingen (DE); Markus MÜLLER, Dintikon (CH); Nicolas LOPEZ, Lenzburg (CH); Ronald J. MOLZ, Farmingville, NY (US); Radek ENZL, Wohlen (CH); Bernd DISTLER, Stony Brook, NY (US)

(73) Assignees: OERLIKON METCO AG, WOHLEN, Wohlen (CH); OERLIKON METCO (US) INC., Westbury, NY (US)

(21) Appl. No.: 19/153,680

(22) PCT Filed: Jan. 29, 2024
(86) PCT No.: PCT/EP2024/000007

§ 371 Date: Aug. 5, 2025

(30) Foreign Application Priority Data
Feb. 7, 2023 (DE) 10 2023 000 417.0

(51) Int. Cl. H05H 1/34; B33Y 80/00; C23C 4/134; H05H 1/42

(52) U.S. Cl. CPC H05H 1/34; B33Y 80/00; C23C 4/134; H05H 1/42; H05H 2245/42

(57) ABSTRACT

A plasma torch head, for interior coatings of rotationally symmetrical, asymmetrical, or freeform surfaces in concave or convex-shaped cavities with a distance between the surfaces to be coated greater than 40 mm using a plasma spraying process, includes a cathode whose tip has a surface roughness of less than Ra 0.2 μm and grooves running in the axial direction of the cathode, which is secured the cathode holder Gas tightness with respect to the plasma gas is ensured by high-temperature resistant O-rings, one O-ring preventing gas leakage between the cathode holder and insulation ring, and another preventing gas leakage between the insulation ring and anode. In the cathode holder, the outflow velocity of the plasma gas in holes above the center of the cathode is lower than below the center. A plasma torch head reduces voltage fluctuations over the entire operational life of the torch head and extends its service life.

### FIELD OF THE INVENTION

The invention relates to a plasma torch head for interior coatings of rotationally symmetrical, asymmetrical, or freeform surfaces in concave or convex-shaped cavities using a plasma spraying process. In interior coatings, the coating lance, equipped with a torch head attached to the lance, is inserted into the component to be coated and coats the rotationally symmetric, asymmetric, or freeform surfaces within the cavities of the component. For coating these surfaces in non-rotationally symmetric components, the lance with the torch head attached to it is rotated, whereas for coating these surfaces in rotationally symmetric components, only the component itself is rotated or both the lance and the component to be coated are rotated.

### BACKGROUND OF THE INVENTION

Plasma torch heads for applying arc wire or plasma interior coatings are well-known and are used in the industry, for example for coating the bores of piston engines. Common coating lances consist of a rotating coating lance with a torch head attached to it or integrated into one end. In the torch head, a plasma jet is generated by an arc between an anode and a cathode and a plasma gas. The plasma jet melts injected powder particles or wire. The molten particles are accelerated by the plasma jet, hit the surface to be coated (substrate), and form a layer on the substrate. In interior coating processes, the plasma jet travels from the torch head towards the substrate in radial direction of the bore or cavity. The coating lance rotates concentrically or eccentrically to the bore axis during coating and is continuously moved up and down along the axis of the bore. This results in the coating being applied to the substrate in a spiral motion. Since, in the case of coating cylinder bores of piston engines, the torch head needs to be inserted into bores having a diameter in the range of 40 to 110 mm, it needs to be built in a compact way to ensure a sufficient spray distance between the torch head and the bore surface. This is especially true for plasma torches used for plasma spray processes using powder as coating material, as these plasma torches are more complex and therefore longer with respect to the axis of the cathode compared to torches used for arc wire spraying.

The prior art approach as outlined in U.S. Pat. No. 4,970,364 solves this challenge by generating a plasma jet along the axial direction of the bore and then deflecting it by 45° from the axial direction of the bore using a nozzle. This axial configuration of the torch head with respect to the bore axis provides more length for plasma generation and, consequently, more volume available for the torch head and allows the use of a long cathode. The media supply to such a torch head can be easily implemented, and cooling is simplified due to the length of the construction. A drawback of this construction is that the plasma jet can only be deflected by a limited angle with respect to the bore axis. In the solution described in U.S. Pat. No. 4,970,364, the angle between the axis of the bore to be coated and the plasma jet is limited to less than 45°. The layer produced using a plasma spray torch of this type exhibits undesirable properties such increased porosity and unmolten particles embedded in the coating applied. These undesirable properties are caused by turbulences within the plasma jet caused by the deflection of the plasma jet within the nozzle. Additionally, due to the high angle between the bore surface and the plasma jet, the efficiency of the coating process is reduced because a higher proportion of the coating particles ricochets from the bore surface rather than adhering to it. The deflection of the plasma jet through a nozzle also results in significant wear of the torch head components and, consequently, a short lifespan of the nozzle of the torch head.

WO 2018/219497 A1 addresses this problem by using a known torch head that generates a plasma jet being nearly perpendicular to the bore surface. The plasma jet is generated in radial direction with respect to the bore axis and exits the front surface of the torch head towards the bore surface. The torch head is attached to a lance by means of a curved intermediate piece, the lance being guided concentric to the bore axis. In order to keep the spray distance between the front surface of the torch head and the surface to be coated constant for different bore sizes to be coated, the eccentricity of the torch head to the lance can be influenced by using different intermediate pieces, each of them creating a different offset between the axis of the lance and thus the axis of the bore and the front surface of the torch head. In the afore-mentioned disclosure, the optimal spray distance between the front surface of the torch head and the bore surface for different bore diameters is achieved by applying the appropriate intermediate piece. As, in the case of WO 2018/219497 A1, the plasma jet is almost perpendicular to the bore surface, the quality of the layer and the efficiency of the coating process can be improved, and the nozzle wear can be reduced compared to the solution shown in U.S. Pat. No. 4,970,364. However, the radial generation of the plasma jet in the torch head with respect to the bore axis leads to design limitations. Since the plasma jet is centered on the axis of the rotationally symmetric cathode, and since the cathode runs radially to the axis of the bore, the cathode must be constructed to be correspondingly short to ensure optimal spraying distance even in small bores. This is especially true if the torch head needs to be inserted into bores with a diameter of 40 to 45 mm. For the above-mentioned construction of the torch head, thermal stress and repeated on-off cycles lead to fluctuations of the voltage and gas leakages between the components of the torch head. These wear phenomena are caused by loosening of the cathode which is fastened to a cathode holder using a thread and gas leakages between the insulating ring and the insulating plate and/or between the cathode holder and the cathode. The inventors have observed that in addition to the effects mentioned above, the surface roughness and the orientation of the structures present on the surface tip influence the voltage fluctuations during the plasma spray process. The cathode used in this prior art approaches show grooves transversal to the axis of rotational symmetry of the cathode and a surface roughness of higher than or equal to Ra 0.4 due to the manufacturing process. The surface roughness, and particularly the transverse grooves of the cathode lead to voltage fluctuations, which intensify over the operating life of the cathode. Increased voltage fluctuations result in undesirable layer properties such as increased porosity. The gas leakages cause unwanted turbulences in the plasma that are detectable in the generated layer.

### Objective of the Invention

The objective of the invention is to create a torch head for a plasma coating lance used for interior coatings, which, at 200 to 800 RPM, exhibits reduced voltage fluctuations and a longer lifespan compared to the solution shown in WO 2018/219497 A1.

### SUMMARY OF THE INVENTION

The objective of the present invention is achieved by a torch head with the features of independent claim 1. The respective dependent claims relate to particularly advantageous embodiments of the invention. The inventive torch head is characterized by a cathode, the tip of which has a surface roughness of less than or equal to Ra 0.2 μm and is preferably provided with grooves axial with respect to the cathode axis. The cathode is secured in the cathode holder, which has a rounded inlet channel for the plasma gas, using a self-locking Spiralock thread. Gas tightness between the cathode holder and the cathode is achieved through an insulator equipped with O-rings.

The afore-mentioned features result in reduced voltage fluctuations over the entire lifetime of the torch head and an extended lifetime. The low surface roughness of the cathode tip, the axial grooves on the tip of the cathode and preventing the cathode from becoming loose reduce voltage fluctuations and increase the lifetime of the torch head. Additionally, the gas seal between the insulator and the anode, as well as the optimized inflow of plasma gas, lead to an increased lifetime of the torch head and to reduced turbulences of the plasma.

### BRIEF DESCRIPTION OF THE DRAWINGS

FIG. 1 illustrates the process of interior coating using a plasma torch head.

FIG. 2 illustrates the cross-section of an inventive plasma torch head for interior coatings.

FIG. 3 shows a cathode used for the inventive plasma torch head.

FIG. 4 illustrates an inventive cathode holder optimized with regards to the plasma gas flow.

FIG. 5 depicts the voltage profile for a known plasma torch head for interior coatings.

FIG. 6 depicts the voltage profile for an inventive plasma torch head for interior coatings.

### DETAILED DESCRIPTION OF EMBODIMENTS

The invention and its positive impact on voltage fluctuations and, consequently, the layer quality is now illustrated by way of non-limiting examples based on the figures.

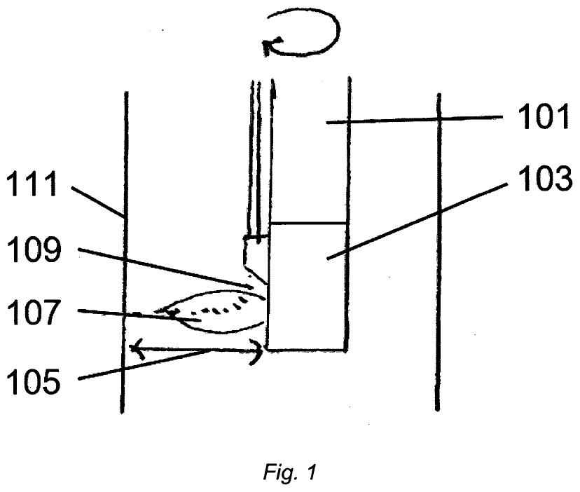

As shown FIG. 1, the plasma torch head (103) attached to a lance (101) rotates in a cavity that can be rotationally symmetrical, asymmetrical, or consist of freeform surfaces in concave or convex shapes. In the plasma torch head, a plasma jet (107) is generated using an electric arc with the help of plasma gas. Powder particles (109), transported by carrier gas, are injected into the plasma jet, melted, accelerated towards the substrate (111), and deposited on it to create a layer. If the cavity to be coated is a bore, the spray distance (105) is adjusted to a value between 20 mm and 65 mm by offsetting the axis of the lance from the axis of the bore. When non-rotationally symmetrical inner surfaces are coated with the plasma torch head, the spray distance can be adjusted by the movement path of the plasma torch head.

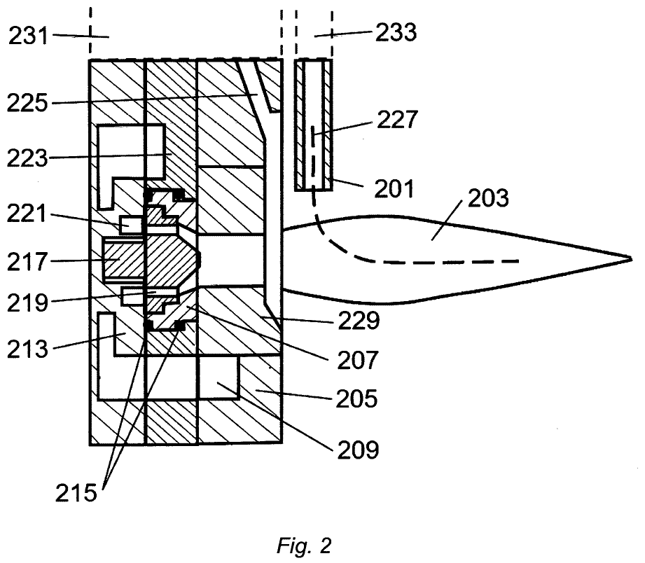

In FIG. 2, an inventive plasma torch head is shown. As shown in FIG. 2, the torch head is attached to a lance or intermediate piece (231) and the injector (201) is connected to a powder-gas hose (233) through which a powder-gas mixture is supplied. An electric arc is formed between the cathode (217) and the anode (205) by an ignition spark. The plasma gas supplied through gas channels of the cathode (217) and the electric arc are transformed into a plasma (203). The plasma melts the powder particles (227) transported using carrier gas through the injector (201). The plasma is enveloped by a shroud gas which reduces oxidation of the coating material during the coating process. The shroud gas is supplied through a gas channel (225). The cathode (217) and the anode (205) are electrically insulated, except for the cathode tip (305). In a preferred embodiment of the torch head, electrical isolation is achieved using an insulation plate (223) and an insulation ring (207) mounted concentrically to the cathode (217). In some embodiments, the insulation plate comprises cooling gas channels opening towards the sides of the torch head and/or towards the opposite side of the plasma jet for cooling the substrate during the coating process. Due to thermal stress, the insulation ring (207), which consists of two surfaces running concentrically to the cathode axis and can also be concave or convex in relation to the cathode axis, is made of a ceramic material. In the preferred embodiment, the insulation plate (223) has two parallel surfaces for attaching the anode and the cathode holder (213), as well as holes for accommodating the insulation ring and for passing cooling water between the anode and the cathode holder. To enable the replacement of individual worn components, the cathode (217) and cathode holder (213) are preferably separate components, with the cathode being screwed into the cathode holder. The cathode holder comprises inlets, not shown in FIG. 2, for plasma gas and plasma gas channels (221) through which the plasma gas is transported to the cathode (217). To ensure that the plasma gas exits exclusively through the gas channels (219) in the cathode (217), sealing rings (215) are placed in the preferred embodiment in the axial direction of the cathode between the cathode holder (213) and insulation ring (207) on one side and between the insulation ring (207) and anode (205) on the other side. In a preferred embodiment, the sealing rings (215) are made from a heat-resistant material allowing for operating temperatures of up to 300° C. The cathode (217) is secured in the cathode holder (213) using a self-locking fastener, preferably with a self-locking Spiralock thread. The cathode holder (213) and the anode (205) are cooled by water supplied through a channel (209). The cooling water is supplied to the anode (205) from the lance using water inlets, not shown in FIG. 2, and exits the torch head through outlets, also not shown in FIG. 2, in the insulation plate (223). In the embodiment shown in FIG. 2, the anode (205) comprises an insert (229) made from a copper-alloy. In some embodiments, the anode may comprise cooling gas channels opening towards the substrate. In some embodiments, electrically insulating covers not shown in FIG. 4 are applied to the torch head on the side opposite to the end of the lance and/or on the cathode holder to prevent an electrical discharge in case of collision with the surface to be coated.

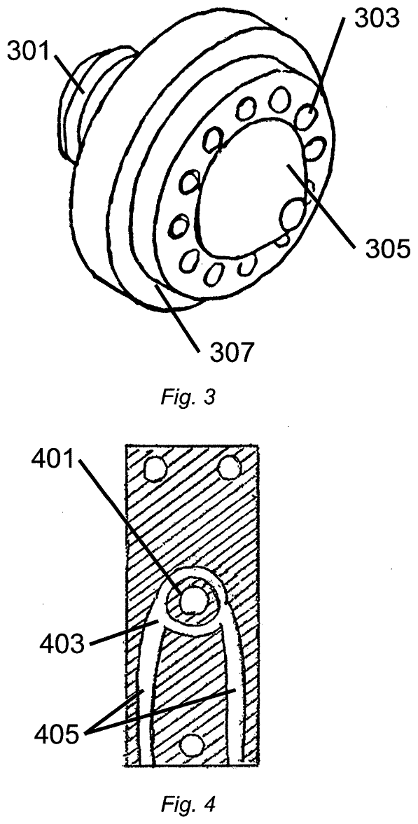

The cathode shown in FIG. 3 comprises a cathode body (307) and a cathode tip (305) inserted into the cathode body. The cathode body (307) has a thread (301) for attachment in the cathode holder, the thread being elongated compared to the prior art approach as shown in WO 2018/219497 A1. In a preferred embodiment, the length of the thread (301) on the cathode, as measured along the axis of rotational symmetry of the cathode, is between 2.5 and 5 mm, preferably between 3 and 4 mm and even more preferably between 3 and 3.5 mm. Plasma gas is supplied through bores (303) arranged radially to the axis of the cathode. In a preferred embodiment, the cross-section of the bores is circular shaped. However, the cross-section may also be non-circular shaped such as oval or elliptical. In a preferred embodiment, the axial section through the cathode tip (305) has a conical or elliptical paraboloid shape. The surface roughness of the cathode tip (305) is brought to a value of maximum Ra 0.2 μm using a post-turning or milling process. The post-processing of the cathode tip is preferably done by lapping but can also be done by abrasive flow machining or polishing. During the polishing process, the grooves introduced radially to the cathode axis by the mechanical pre-processing are removed. In an alternative embodiment of post-processing, targeted surface structures such as grooves or ridges can also be achieved axially to the cathode axis, further reducing voltage fluctuations.

As shown in FIG. 4, the cathode is screwed into the bore (401) of the cathode holder, which is equipped with a self-locking fastener, in this embodiment with a self-locking Spiralock thread. Either the cathode holder, the cathode, or both the cathode holder and cathode can be equipped with a self-locking thread. In a preferred embodiment, the length of the thread (301), as measured along the axis of rotational symmetry of the cathode, applied to the cathode is between 2.5 and 5 mm, preferably between 3 and 4 mm and even more preferably between 3 and 3.5 mm. The self-locking thread prevents the cathode from loosening over the course of operation due to thermally induced movements of the cathode holder. By preventing the cathode from loosening, voltage fluctuations can be reduced, especially after a certain operational period, thereby increasing the lifespan of the torch head. The plasma gas is supplied to the cathode through channels (405), optimized with CFD simulation, which lead into an annular recess (403). From this annular recess, the plasma gas flows through the bores (303) of the cathode. The CFD simulation has shown that the exit velocity of the plasma gas through the bores (303) of the cathode being located above the center axis of the cathode in terms of the axial direction of the lance, should be lower than exit velocity of the plasma gas through the bores in the lower half of the cathode. The above-mentioned distribution of the plasma gas flow reduces turbulences. The reduction of turbulences in the inflowing plasma gas leads to an improved layer quality. To manufacture the complex geometry of the channels (405) within the cathode, an additive manufacturing process can be used, creating the component layer-by-layer.

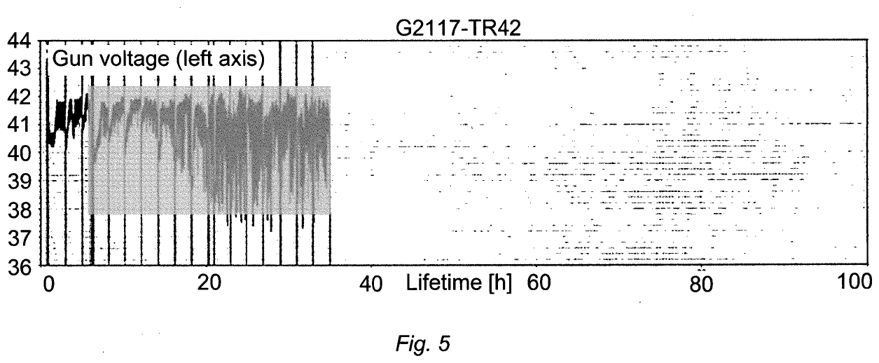

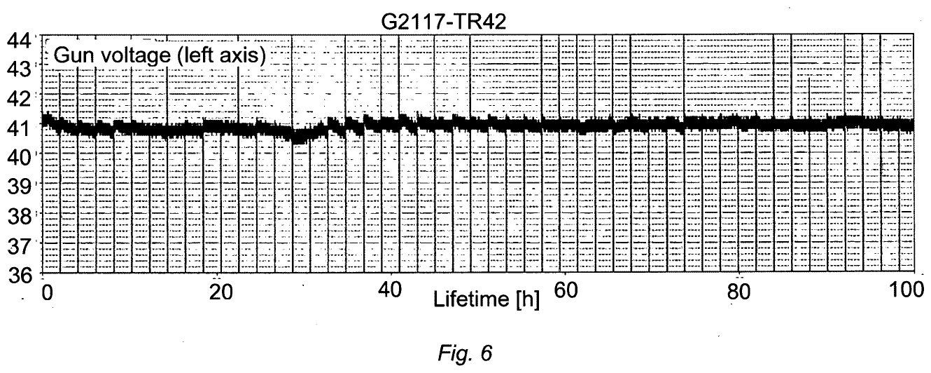

The voltage profile depicted in FIG. 5 for a known plasma torch head used for interior coatings shows that voltage fluctuations increase after an operational period of 20 hours. Starting from an acceptable voltage fluctuation of +/−2 volts around the nominal voltage of 40 volts, it can be observed that the lower voltage measurements fall below the acceptable lower voltage level of 38 V after 20 h. Thus, the end of the lifespan of the known plasma torch head is reached after 20 operating hours. If the allowable voltage fluctuation of +/−2 volts is exceeded, the torch head must be revised, and the anode and/or cathode must be replaced. The short-term voltage spikes shown in FIGS. 5 and 6 of 44 volts or higher correspond to the higher ignition voltage applied during the ignition process. The short-term voltage drops below 36 V down to 0 Volt indicate that a single operation cycle, starting with a short-term voltage spike of 44 V or higher is ending with the shut-down of the gun.

FIG. 6 shows that the use of an inventive plasma torch head for interior coatings significantly reduces voltage fluctuations during a single operation cycle. The voltage fluctuations of an inventive plasma torch head are limited to less than +/−1 V within a single operation cycle and for a period of 100 operating hours and more. A comparison of the number operation cycles in FIG. 5 with FIG. 6 also shows that the number of operation cycles can be increased using an inventive plasma torch head compared to using a prior art plasma torch head. This shows that the use of an inventive plasma torch does not only reduce the voltage fluctuations compared to the known plasma torch head for interior coatings but also extends the lifespan to over 100 operating hours.

A torch head for interior coatings of rotationally symmetric, asymmetric, or free-form surfaces in concave or convex-shaped cavities of components with a distance between the surfaces to be coated of greater than or equal to 40 mm is disclosed using a plasma spray process. The torch head comprises an anode (205) and a cathode (217) with axial symmetry, preferably rotationally symmetric. The anode (205) and cathode (217), except for the cathode tip (305), are electrically separated by an insulation plate (223) and an insulation ring (207). The cathode tip (305) has a surface finish of less than or equal to Ra 0.2 μm and, in a preferred embodiment, features grooves in the axial direction of the cathode. The cathode is secured in a cathode holder (213) using self-locking fasteners, preferably with a self-locking Spiralock thread. In embodiments, the self-locking thread can be applied to the cathode and/or the cathode holder. The channels for supplying plasma gas to the plasma in the disclosed torch head are designed so that the exit velocity of the plasma gas in the holes (303) of the cathode, which are located above the midpoint of the cathode in terms of the axial direction of the lance, is lower than in the holes below the midpoint. Gas tightness between the cathode (217) and anode (205) is ensured by an O-ring, preferably multiple, and particularly preferably by two O-rings (215).

A method for manufacturing a torch head has been disclosed, wherein a surface roughness of less than or equal to Ra 0.2 is achieved on the cathode tip (305), and preferably, grooves are introduced in the axial direction of the cathode tip.

Furthermore, a method for manufacturing the cathode holder (213) using an additive manufacturing process has been disclosed, preferably through layer-by-layer construction.

1. A torch head for interior coating of rotationally symmetrical, asymmetrical, or free-form surface-concave or convex-shaped cavities of components with a distance between the surfaces to be coated greater than or equal to 40 mm using a plasma spray process, the torch head comprising:
an anode and
a cathode with axial symmetry, preferably rotationally symmetrical,
the anode and cathode except for the cathode tip being electrically separated from each other by an insulation plate and an insulation ring the cathode tip having a surface roughness of less than or equal to Ra 0.2 μm, and the cathode being secured in a cathode holder using self-locking fasteners.

2. The torch head according to claim 1, wherein the cathode holder and/or the cathode comprise a self-locking thread.

3. The torch head according to claim 1, wherein the exit velocity of the plasma gas in the bores of the cathode, which are, seen in relation to the axial direction of the lance, above the axis of rotational symmetry of the cathode, is lower than in the bores below the center.

4. The torch head according to claim 1, wherein the cathode tip comprises grooves in the axial direction of the cathode.

5. The torch head according to claim 1, wherein the gas tightness between cathode and anode is ensured by an O-ring, preferably several, and particularly preferably by two O-rings.

6. A method for manufacturing a torch head according to claim 1, wherein a surface roughness of less than or equal to Ra 0.2 is achieved during the production of the cathode tip.

7. The method for manufacturing a torch head according to claim 1, wherein grooves running in the axial direction of the cathode tip are introduced during the production of the cathode tip.

8. The method for manufacturing a torch head according to claim 1, wherein the cathode holder is manufactured by an additive manufacturing process, preferably through layer-by-layer construction.
